(19) United States
(12) Patent Application Publication
(10) Pub. No.: US 2005/0092679 A1
(43) Pub. Date: May 5, 2005

(54) Method of cleaning or purifying a polymer

(75) Inventor: Richard Warby, Norfolk (GB)

Correspondence Address: BACON & THOMAS, PLLC, 625 SLATERS LANE, FOURTH FLOOR, ALEXANDRIA, VA, 22314, US

(73) Assignee: Bespak plc, Norfolk (GB)

(21) Appl. No.: 10/694,783

(22) Filed: Oct. 29, 2003

(51) Int. Cl. B01D 11/00

(52) U.S. Cl. 210/634; 528/491; 528/480

(57) ABSTRACT

A method of cleaning or purifying a polymer which is intended for medical or pharmaceutical use, which method comprises contacting the polymer with an extracting solvent comprising or consisting of an aliphatic alcohol, whereby impurities contained in the polymer are substantially extracted.

A method of cleaning or purifying a polymer The present invention relates to a method of cleaning or purifying polymers, which term encompasses both plastics and elastomers, and polymeric articles and, particularly, polymers and articles which are intended for medical or pharmaceutical uses.

The present invention is particularly concerned with a dispensing apparatus and component parts thereof for dispensing pressurised fluid in the form of an aerosol. Such an apparatus may, for example, be used for dispensing medicine or products in solution or suspension in an alcohol base.

The elimination of extractables and leachables from polymeric articles is particularly important when the articles will come into contact with a pharmaceutical product.

For example, this is the case for plastic articles used in components, such as valves, of dispensing devices such as metered dose inhalers (MDI), dry powder inhalers (DPI) and nasal sprays.

The term “extractables” as used herein is intended to cover chemical species that migrate from packaging components or other components in an appropriate solvent. In devices such as those mentioned above, the “solvent” will typically be the particular propellant used.

Leachables cover chemical species that migrate from packaging or other components under normal conditions of use or during the shelf life of a drug product. Leachables are substances detected in the pharmaceutical formulation.

In devices such as metered dose inhalers (MDI), both extractables and leachables may increase impurities of drug products to unacceptable levels, as well as potentially reacting with the drug product, vehicle or excipients.

The metering valves used in dispensing devices such as pressurised metered dose inhalers are typically constructed of a mixture of metal and/or plastic parts and elastomeric rubber parts. It is important that the valve parts are compatible with the particular aerosol propellant with which they will come into contact.

It is known from GB-1201918 to provide a dispensing apparatus in which pressurised fluid from a pressurised dispensing container is released by a valve in a substantially controlled manner, the valve including elastomeric seals which are annular and which co-operate with a sliding valve stem to open and close fluid ports.

Known rubber compounds for sealing pharmaceutical metered dose aerosol inhalers are based on the traditional technology of vulcanising a synthetic or natural rubber polymer.

The required material properties necessary for good seal performance for pharmaceutical applications include: chemical compatibility (swell), tensile strength, permanent compression set, stress relaxation, elastic modulus, and regulatory compliance.

Products to be dispensed are commonly provided in solution or suspension in an alcohol base, this being particularly common in the dispensing of medicinal compounds for inhalation therapy.

It is an object of the present invention to provide a method of cleaning or purifying a polymer which is intended for medical or pharmaceutical use seal material for a dispensing apparatus which addresses at least some of the problems associated with the prior art.

Accordingly, in a first aspect, the present invention provides a method of cleaning or purifying a polymer which is intended for medical or pharmaceutical use, which method comprises contacting the polymer with an extracting solvent comprising or consisting of an aliphatic alcohol, whereby impurities contained in the polymer are substantially extracted.

The extracting solvent is chosen so as to reduce or substantially eliminate a large number of extractables from the polymer.

The aliphatic alcohol preferably comprises ethanol, which is preferably of high purity, more preferably DRAA ethanol.

In one embodiment, the polymer is an elastomer, which will typically be formed into an elastomeric article before being contacted with the extracting solvent. The elastomeric article is preferably a seal for a pharmaceutical dispensing device.

The elastomer preferably comprises an isobutylene polymer or co-polymer thereof, preferably selected from one or more of polyisobutylene, polybutene, butyl rubber, halogenated butyl rubber, including derivatives thereof. More preferably, the elastomer comprises one or more of butyl rubber, bromobutyl rubber and/or chlorobutyl rubber.

Butyl rubber is a copolymer made from isobutylene and a small amount of a diolefin such as, for example, isoprene (2-methylbuta-1,3-diene). Typically, butyl rubber comprises approximately 97% isobutylene and approximately 3% isoprene, and it may be polymerized using an aluminium chloride catalyst. Halogenated butyl rubbers such as bromobutyl rubber and chlorobutyl rubber may be made by treating isoprene-isobutylene rubber with bromine/chlorine.

It will be appreciated that the elastomeric composition may comprise a blend of an isobutylene polymer or co-polymer thereof with another polymer, such as a chlorine-substituted diene polymer. For example, a blend of butyl and polychloroprene may be used. Blending of polychloroprene with the non-polar butyl is advantageous as it allows dissipation of static charge. Static charge builds up during the automated valve assembly process and can cause seats to self adhere and pose problems in valve assembly.

The aforementioned elastomeric compositions will typically be produced with the aid of a cross-linking agent (also known as a curing agent) provides or facilitates network formation to result in a three-dimensional polymer network structure. The cross-linking agent may act by reacting with the functional groups on the polymer chain. The cross-linking agent will typically comprise sulphur or a sulphur-containing compound. The cross-linking agent is preferably substantially free of any peroxide curing agents such as, for example, dicumyl peroxide.

An accelerator may also be used so as to reduce the time required for curing/cross-linking. Accelerators may also act to improve the ageing characteristics and other physical properties of the rubber. Examples of accelerators include sulphenamides, guanidines, thioureas, thiazoles, dithiocarbamates (eg tellurium diethyldithio carbamate), thiuram sulphides (eg dipentamethylene thiuram hexasulphide and tetramethylthiuram disulphide), zinc oxide and tertiary amines, and mercaptobenzothiazole derivatives for example MBTS (dibenzthiazyle disulphide), and sulphur curing agents, together with MBTS and optionally thiuram (TMTD, tetramethyl thiuram disulphide).

The seal may be used in a valve for use in a pharmaceutical dispensing device, such as, for example, a nasal, pulmonary or transdermal delivery device. A preferred use of the seal is in a pharmaceutical metered dose aerosol inhaler device (MDI).

The term pharmaceutical as used herein is intended to encompass any pharmaceutical, compound, composition, medicament, agent or product which can be delivered or administered to a human being or animal, for example pharmaceuticals, drugs, biological and medicinal products. Examples include antiallergics, analgesics, bronchodilators, antihistamines, therapeutic proteins and peptides, antitussives, anginal preparations, antibiotics, anti-inflammatory preparations, hormones, or sulfonamides, such as, for example, a vasoconstrictive amine, an enzyme, an alkaloid, or a steroid, including combinations of two or more thereof. In particular, examples include isoproterenol [alpha-(isopropylaminomethyl) protocatechuyl alcohol], phenylephrine, phenylpropanolamine, glucagon, adrenochrome, trypsin, epinephrine, ephedrine, narcotine, codeine, atropine, heparin, morphine, dihydromorphinone, ergotamine, scopolamine, methapyrilene, cyanocobalamin, terbutaline, rimiterol, salbutamol, flunisolide, colchicine, pirbuterol, beclomethasone, orciprenaline, fentanyl, and diamorphine, streptomycin, penicillin, procaine penicillin, tetracycline, chlorotetracycline and hydroxytetracycline, adrenocorticotropic hormone and adrenocortical hormones, such as cortisone, hydrocortisone, hydrocortisone acetate and prednisolone, insulin, cromolyn sodium, and mometasone, including combinations of two or more thereof.

The pharmaceutical may be used as either the free base or as one or more salts conventional in the art, such as, for example, acetate, benzenesulphonate, benzoate, bircarbonate, bitartrate, bromide, calcium edetate, camsylate, carbonate, chloride, citrate, dihydrochloride, edetate, edisylate, estolate, esylate, fumarate, fluceptate, gluconate, glutamate, glycollylarsanilate, hexylresorcinate, hydrobromide, hydrochloride, hydroxynaphthoate, iodide, isethionate, lactate, lactobionate, malate, maleate, mandelate, mesylate, methylbromide, methylnitrate, methylsulphate, mucate, napsylate, nitrate, pamoate, (embonate), pantothenate, phosphate, diphosphate, polygalacturonate, salicylate, stearate, subacetate, succinate, sulphate, tannate, tartrate, and triethiodide, including combinations of two or more thereof. Cationic salts may also be used, for example the alkali metals, e.g. Na and K, and ammonium salts and salts of amines known in the art to be pharmaceutically acceptable, for example glycine, ethylene diamine, choline, diethanolamine, triethanolamine, octadecylamine, diethylamine, triethylamine, 1-amino-2-propanol-amino-2-(hydroxymethyl)propane-1,3-diol, and 1-(3,4-dihydroxyphenyl)-2 isopropylaminoethanol.

The pharmaceutical will typically be one which is suitable for inhalation and may be provided in any suitable form for this purpose, for example as a powder or as a solution or suspension in a solvent or carrier liquid, for example ethanol.

The pharmaceutical may, for example, be one which is suitable for the treatment of asthma. Examples include salbutamol, beclomethasone, salmeterol, fluticasone, formoterol, terbutaline, sodium chromoglycate, budesonide and flunisolide, and physiologically acceptable salts (for example salbutamol sulphate, salmeterol xinafoate, fluticasone propionate, beclomethasone dipropionate, and terbutaline sulphate), solvates and esters, including combinations of two or more thereof. Individual isomers such as, for example, R-salbutamol, may also be used. As will be appreciated, the pharmaceutical may comprise of one or more active ingredients, an example of which is flutiform, and may optionally be provided together with a suitable carrier, for example a liquid carrier. One or more surfactants may be included if desired.

The seal may advantageously further includes a filler, preferably a mineral filler. Mineral fillers are preferable to carbon black in order to minimise the formation of polynuclear aromatic hydrocarbon compounds. Suitable examples include any of magnesium silicate, aluminium silicate, silica, titanium oxide, zinc oxide, calcium carbonate, magnesium oxide magnesium carbonate, magnesium aluminium silicate, aluminium hydroxide, talc, kaolin and clay, including combinations of two or more thereof. Preferably, the filler is or comprises one or more of magnesium silicate, talc, calcined clay, kaolin and/or amino silane coated clay.

The seal further preferably further includes a process aid, preferably a low molecular weight polyethylene.

The seal may further comprise any of a reinforcement agent, a plasticizer, a binder, a stabilizer, a retarder, a bonding agents, an antioxidant, a lubricant, a pigment, a wax, a resin, an antiozonants, a secondary accelerator or an activator, including combinations of two or more thereof. Examples of antioxidants are 2:2′-methylene-bis(6-(1-methyl-cyclohexyl)-para-creosol) and octylated diphenylamine. An advantage of the seal according to the present invention is that it can be essentially free of an antioxidant if desired.

It will be appreciated that certain constituents may have more than one effect. For example, zinc oxide may act as an activator and as a filler. Similarly, magnesium oxide may act as an acid absorber and as a filler.

The term seal as used herein is intended to encompass any sealing member or portion thereof present in a pharmaceutical dispensing device, including, but not limited to, gaskets, seats and seals whether static or dynamic.

The present invention also provides a valve for use in a pharmaceutical dispensing device and having a seal as herein described.

It will be appreciated that the seal may be provided as a separate component or may be formed integrally with the valve.

The present invention also provides a pharmaceutical dispensing device having a valve as herein described. The pharmaceutical dispensing device may be, for example, a nasal, pulmonary or transdermal delivery device. A preferred device is a pharmaceutical metered dose aerosol inhaler device.

The present invention also provides a dispensing apparatus for dispensing pressurised fluid comprising a valve body defining a chamber, a valve member extending movably through the chamber and through at least one annular seal co-operating with the valve member and the body to regulate the discharge of fluid, wherein the or at least one of the seals is as herein described.

Such a device may be used for dispensing medicine, pharmaceuticals, biological agents, drugs and/or products in solution or suspension as herein described.

In a preferred embodiment, the dispensing apparatus comprises a pressurised dispensing container having a valve body provided with two annular valve seals through which a valve member is axially slidable, the seals being disposed at inlet and outlet apertures of a valve chamber so that the valve functions as a metering valve.

The dispensing apparatus as herein described may comprise a pressurised dispensing container operatively connected to the valve body and containing the fluid to be dispensed and a hydrofluorocarbon propellant comprising propellant type 134a or 227. The designation of propellant types referred to in the present application is as specified in British Standard BS4580:1970 “Specification for number designations of organic refrigerants”. Accordingly, propellant 134a is: 1,1,1,2-tetrafluoroethane CH₂F—CF₃ and propellant 227 is: 1,1,1,2,3,3,3 heptafluoropropane CF₃—CHF—CF₃.

The fluid to be dispensed typically comprises a liquid or particulate product as a solution or suspension in a carrier liquid. The carrier liquid preferably comprises an alcohol such as ethanol. One or more surfactants may be present.

The present invention provides particularly favourable results when used in conjunction with a hydrofluorocarbon propellant in the aerosol device.

In another embodiment, the polymer is formed into a polymeric article after being contacted with the extracting solvent. The polymeric article is preferably a pharmaceutical dispensing device or a component part thereof, for example a body, a chamber, a stem, a core, a core extension or a valve part of a pharmaceutical dispensing device.

In this embodiment, the polymer preferably comprises one or more of polyethylene, polypropylene, polystyrene, polyvinylchloride, polycarbonate, nylon, polyacetal (including acetal resin) and polyester, including derivatives thereof.

The present invention also provides a seal for a valve for use in a pharmaceutical dispensing device, which seal is formed from an elastomeric composition comprising an isobutylene polymer or co-polymer thereof, optionally a cross-linking agent for the isobutylene polymer or co-polymer thereof, and optionally an accelerator for the cross-linking agent, wherein the seal and/or elastomeric composition has/have been contacted with an extracting solvent comprising or consisting of an aliphatic alcohol, whereby impurities contained in the seal and/or elastomeric composition are substantially extracted.

The present invention also provides an article selected from a body, a chamber, a stem, a core, a core extension and a valve part of a pharmaceutical dispensing device as herein described, said article being formed from a polymer selected from one or more of polyethylene, polypropylene, polystyrene, polyvinylchloride, polycarbonate, nylon, polyacetal and polyester, including derivatives thereof, wherein the article and/or polymer has/have been contacted with an extracting solvent comprising or consisting of an aliphatic alcohol, whereby impurities contained in the article and/or polymer are substantially extracted.

The present invention also provides a process for the preparation of an elastomeric seal for a valve for use in a pharmaceutical dispensing device as herein described, the process comprising:

(i) providing an elastomeric composition comprising or consisting of an isobutylene polymer or co-polymer thereof;

(ii) forming the elastomeric composition into a seal; and

(iii) contacting the seal with an extracting solvent comprising or consisting of an aliphatic alcohol, whereby impurities contained in the seal are substantially extracted.

The present invention also provides a process for the preparation of an elastomeric seal for a valve for use in a pharmaceutical dispensing device as herein described, the process comprising:

(i) providing a composition comprising a mixture of an isobutylene polymer or co-polymer thereof, a cross-linking agent for the isobutylene polymer or co-polymer thereof, and an optional accelerator for the cross-linking agent;

(ii) initiating a cross-linking reaction in the mixture to form a cross-linked elastomeric composition;

(iii) forming the elastomeric composition into a seal; and

(iv) contacting the seal with an extracting solvent comprising or consisting of an aliphatic alcohol, whereby impurities contained in the seal are substantially extracted.

As mentioned above, the aliphatic alcohol is preferably ethanol, and preferably of high purity, more preferably DRAA ethanol.

The step of forming the composition into a seal may involves one or more forming techniques selected from compression moulding, injection moulding and extrusion.

The present invention also provides a process for the preparation of an article selected from a body, a chamber, a stem, a core, a core extension and a valve part of a pharmaceutical dispensing device as herein described, the process comprising:

(i) providing a polymer composition selected from one or more of polyethylene, polypropylene, polystyrene, polyvinylchloride, polycarbonate, nylon, polyacetal and polyester, including derivatives thereof

(ii) forming the composition into said article; and

(iii)contacting said article with an extracting solvent comprising or consisting of an aliphatic alcohol, whereby impurities contained in the composition are substantially extracted.

The step of forming the composition into a seal may involve one or more forming techniques such as compression moulding, injection moulding and/or extrusion.

The initiation of the cross-linking reaction (if required) may be achieved by any of the known conventional techniques, for example heating the formulation to at least the curing reaction temperature, which is typically in the range of from 130 to 200° C. A preferred process involves forming rubber compound strips (typically of approximately 1 mm thickness) by compression moulded. The moulding temperature is typically in the range 160°-180° C. The cure time is typically in the range 1-10 minutes. The moulded strips are preferably post cured in an air oven for typically 1 hour at 150° C.

The strips may then be made into gaskets (seats) using a punching device.

In the present invention plastic and elastomer components may be ethanol extracted to reduce the level of leachable species that could migrate into drug mixtures. In this process, the components are preferably loaded into a glass or stainless steel column and washed by refluxing ethanol. The ethanol percolates through the elastomer and plastic components and extracts the extractable compounds. The ethanol with the extractable may be reheated in for example a boiler and the ethanol then recycled. The extracted compounds remaining in the boiler because they typically boil at a much higher temperature than ethanol and therefore do not tend to vaporise.

The process of the present invention may further comprise a step of drying. Drying is preferably achieved by exposing the cleaned plastic articles to heated, filtered atmospheric air. The air may be passed into the bottom of the extraction column whereby it circulates upwards amongst the cleaned articles.

The terms cleaning and purifying as used interchangeably throughout this specification and the terms are applied when the reduction in extractables meets the required levels.

The present invention also provides a polymer or plastic article free or substantially free of extractables which has undergone a cleaning or purification process according to the present invention.

1. A method of cleaning or purifying a polymer which is intended for medical or pharmaceutical use, which method comprises contacting the polymer with an extracting solvent comprising or consisting of an aliphatic alcohol, whereby impurities contained in the polymer are substantially extracted.

2. A method as claimed in claim 1, wherein the aliphatic alcohol is ethanol.

3. A method as claimed in claim 1, wherein the polymer is an elastomer.

4. A method as claimed in claim 3, wherein the elastomer is formed into an elastomeric article before being contacted with the extracting solvent.

5. A method as claimed in claim 4, wherein the elastomeric article is or comprises a seal for a pharmaceutical dispensing device.

6. A method as claimed in claim 3, wherein the elastomer is or comprises an isobutylene polymer or co-polymer thereof, preferably selected from one or more of polyisobutylene, polybutene, butyl rubber, halogenated butyl rubber, including derivatives thereof.

7. A method as claimed in claim 6, wherein the elastomer is or comprises one or more of butyl rubber, bromobutyl rubber and/or chlorobutyl rubber.

8. A method as claimed in claim 6, wherein the elastomer is or comprises a blend of an isobutylene polymer or co-polymer thereof with another polymer, preferably a chlorine-substituted diene polymer.

9. A method as claimed in claim 8, wherein the elastomer is or comprises a blend of butyl or bromobutyl rubber and polychloroprene.

10. A method as claimed in claim 1, wherein the polymer is formed into a polymeric article after being contacted with the extracting solvent.

11. A method as claimed in claim 10, wherein the polymeric article is a pharmaceutical dispensing device or a component part thereof.

12. A method as claimed in claim 11, wherein the polymeric article is selected from one or more of a body, a chamber, a stem, a core, a core extension and a valve part of a pharmaceutical dispensing device.

13. A method as claimed in claim 1, wherein the polymer is or comprises one or more of polyethylene, polypropylene, polystyrene, polyvinylchloride, polycarbonate, nylon, polyacetal and polyester, including derivatives thereof.

14. A seal for a valve for use in a pharmaceutical dispensing device, which seal is formed from an elastomeric composition comprising an isobutylene polymer or co-polymer thereof, optionally a cross-linking agent for the isobutylene polymer or co-polymer thereof, and optionally an accelerator for the cross-linking agent, wherein the seal and/or elastomeric composition has/have been contacted with an extracting solvent comprising or consisting of an aliphatic alcohol, whereby impurities contained in the seal and/or elastomeric composition are substantially extracted.

15. A seal as claimed in claim 14, wherein the elastomeric composition comprises one or more of polyisobutylene, polybutene, butyl rubber, halogenated butyl rubber, including derivatives thereof.

16. A seal as claimed in claimed in claim 14, wherein the seal further includes a mineral filler.

17. A seal as claimed in claim 16, wherein the mineral filler is selected from one or more of magnesium silicate, aluminium silicate, silica, titanium oxide, zinc oxide, calcium carbonate, magnesium oxide magnesium carbonate, magnesium aluminium silicate, aluminium hydroxide, talc, kaolin, clay and amino silane coated clay.

18. A seal as claimed in claim 14, wherein the seal further includes a process aid, preferably a low molecular weight polyethylene.

19. A seal as claimed in claim 14, wherein the seal further comprising one or more of a reinforcement agent, a plasticizer, a binder, a stabilizer, a retarder., a bonding agents, an antioxidant, a lubricant, a pigment, a wax, a resin, an antiozonants, a secondary accelerator or an activator.

20. A valve for use in a pharmaceutical dispensing device having a seal as defined in claim 14.

21. A pharmaceutical dispensing device having a valve as claimed in claim 20.

22. A pharmaceutical dispensing device as claimed in claim 21 which is a pharmaceutical metered dose aerosol inhaler device.

23. A dispensing apparatus for dispensing pressurised fluid comprising a valve body defining a chamber, a valve member extending movably through the chamber and through at least one annular seal co-operating with the valve member and the body to regulate the discharge of fluid, wherein the or at least one of the seals is as defined in claim 14.

24. A dispensing apparatus which comprises a pressurised dispensing container having a valve body provided with two annular valve seals through which a valve member is axially slidable, said seals being disposed at inlet and outlet apertures of a valve chamber so that the valve functions as a metering valve, wherein at least one of the annular valve seals is as defined in claim 14.

25. A dispensing apparatus as claimed in claim 23, comprising a pressurised dispensing container operatively connected to the valve body and containing the fluid to be dispensed and a hydrofluorocarbon propellant comprising propellant type 134a or 227.

26. A dispensing apparatus as claimed in claim 24, comprising a pressurised dispensing container operatively connected to the valve body and containing the fluid to be dispensed and a hydrofluorocarbon propellant comprising propellant type 134a or 227.

27. A dispensing apparatus as claimed in claim 26, wherein the fluid to be dispensed comprises a liquid or particulate product as a solution or suspension in a carrier liquid comprising alcohol.

28. A dispensing apparatus as claimed in claim 27, wherein the alcohol comprises ethanol.

29. An article selected from a body, a chamber, a stem, a core, a core extension and a valve part of a pharmaceutical dispensing device, said article being formed from a polymer selected from one or more of polyethylene, polypropylene, polystyrene, polyvinylchloride, polycarbonate, nylon, polyacetal and polyester, including derivatives thereof, wherein the article and/or polymer has/have been contacted with an extracting solvent comprising or consisting of an aliphatic alcohol, whereby impurities contained in the article and/or polymer are substantially extracted.

30. A process for the preparation of an elastomeric seal for a valve for use in a pharmaceutical dispensing device, the process comprising:
(i) providing an elastomeric composition comprising or consisting of an isobutylene polymer or co-polymer thereof;
(ii) forming the elastomeric composition into a seal; and
(iii) contacting the seal with an extracting solvent comprising or consisting of an aliphatic alcohol, whereby impurities contained in the seal are substantially extracted.

31. A process for the preparation of an elastomeric seal for a valve for used in a pharmaceutical dispensing device, the process comprising:
(i) providing a composition comprising a mixture of an isobutylene polymer or co-polymer thereof, a cross-linking agent for the isobutylene polymer or co-polymer thereof, and an optional accelerator for the cross-linking agent;
(ii) initiating a cross-linking reaction in the mixture to form a cross-linked elastomeric composition;
(iii) forming the elastomeric composition into a seal; and
(iv) contacting the seal with an extracting solvent comprising or consisting of an aliphatic alcohol, whereby impurities contained in the seal are substantially extracted

32. A process as claimed in claim 30, wherein the aliphatic alcohol is ethanol.

33. A process as claimed in claim 30, wherein the composition is or comprises an isobutylene polymer or co-polymer thereof, preferably selected from one or more of polyisobutylene, polybutene, butyl rubber, halogenated butyl rubber, including derivatives thereof.

34. A process as claimed in claim 30, wherein the step of forming the composition into a seal involves one or more forming techniques selected from compression moulding, injection moulding and extrusion.

35. A process for the preparation of an article selected from a body, a chamber, a stem, a core, a core extension and a valve part of a pharmaceutical dispensing device, the process comprising:
(i) providing a polymer composition selected from one or more of polyethylene, polypropylene, polystyrene, polyvinylchloride, polycarbonate, nylon, polyacetal and polyester, including derivatives thereof
(ii) forming the composition into said article; and
(iii)contacting said article with an extracting solvent comprising or consisting of an aliphatic alcohol, whereby impurities contained in the composition are substantially extracted.
